(19) United States
(12) Patent Application Publication
(10) Pub. No.: US 2009/0147116 A1
(43) Pub. Date: Jun. 11, 2009

(54) IMAGE-CAPTURING APPARATUS, CAMERA, VEHICLE, AND IMAGE-CAPTURING METHOD

(75) Inventors: Shinzo KOYAMA, Osaka (JP); Kazutoshi ONOZAWA, Osaka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/327,146

(22) Filed: Dec. 3, 2008

(30) Foreign Application Priority Data
Dec. 7, 2007 (JP) 2007-317635

(51) Int. Cl. H04N 3/14

(52) U.S. Cl. 348/294

(57) ABSTRACT

The image-capturing apparatus according to the present invention is an image-capturing apparatus including a solid-state imaging device which generates a first image by image-capturing a subject using a first exposure time, a predicted-flare generating unit which generates a predicted-flare image showing a flare component included in the first image, a subtracting unit which generates a difference image by subtracting the predicted-flare image from the first image, and an amplifying unit which generates an amplified image by amplifying the difference image.

### BACKGROUND OF THE INVENTION

(1) Field of the Invention

The present invention relates to an image-capturing apparatus, a camera, a vehicle, and an image-capturing method, and relates particularly to an image-capturing apparatus which reduces a flare component included in an image-captured image.

(2) Description of the Related Art

In image-capturing optical systems, there is a phenomenon in which, when a part of a subject is bright, a scattering of light is seen around the bright part. In particular, the phenomenon in which an image is not formed due to such scattering of light is referred to as a flare.

Flares invariably occur due to optical attributes. However, normally, the value of a flare is small and is not at a level where the effect of the flare is felt by a user viewing the image. However, when an extremely bright subject (hereafter referred to as a “high-brightness subject”) such as a light source is image-captured, the effect of the flare becomes significantly noticeable to the user viewing the image.

In particular, with image-capturing apparatuses such as in-vehicle cameras for visibility assistance, there are many instances where the headlights of an oncoming vehicle, and so on, are image-captured at night. In such cases, flares appear in the image due to the generation of multiple reflections of incident light. Specifically, the flare is caused by the reflection of light in the optical system of a camera such as the influence of the diffraction of an objective lens, multiple reflections between combination lenses, multiple reflections caused by the lens and lens barrel, multiple reflections caused by the lens and imaging device, and multiple reflections caused by the cover glass of the imaging device and the imaging device.

Due to the occurrence of the flare, light is superimposed around the bright portion and dark portions become particularly hard for drivers to see. As such, even when a person or object is present in the dark portion, the driver is unable to recognize the person or object. In other words, flares are a cause for significantly reducing safety for in-vehicle cameras.

In response, image-capturing apparatuses which reduce flares included in the image-captured image are widely known (see Patent References 1 through 3).

Hereinafter, the conventional image-capturing apparatuses which reduce flares, disclosed in Patent References 1 through 3 shall be described.

The image-capturing apparatus disclosed in Japanese Patent No. 3372209 (Patent Reference 1) stores in advance an image pattern model of a flare occurring under a specific optical condition. The image-capturing apparatus disclosed in Patent Reference 1 estimates the brightness and shape of a portion with strong light in the image-captured image, and artificially generates a predicted-flare based on the image pattern model stored in advance. The image-capturing apparatus disclosed in Patent Reference 1 subtracts the artificially generated predicted-flare from the original image in which the actual flare occurs. With this, the image-capturing apparatus disclosed in Patent Reference 1 can compensate for and reduce the flare included in the image to a level that is acceptable for practical use.

In addition, the image-capturing apparatus disclosed in Patent Reference 1 removes the flare using images that are image-captured using two types of exposure times. Specifically, the image-capturing apparatus disclosed in Patent Reference 1 generates the predicted-flare using pixels having brightness greater than a certain value included in an image that is image-captured using a short exposure time. The image-capturing apparatus disclosed in Patent Reference 1 subtracts the generated predicted-flare from an image that is image-captured using a long exposure time. With this, the image-capturing apparatus disclosed in Patent Reference 1 reduces the flare of the image that is image-captured using a long exposure time. In addition, by including electronic shutter adjustment for the short exposure time in an image processing unit, the image-capturing apparatus disclosed in Patent Reference 1 can appropriately adjust sensitivity for the image to be taken using the short exposure time.

Furthermore, Patent Reference 2 and Patent Reference 3 disclose methods for generating predicted-flares.

The image-capturing apparatus disclosed in Japanese Unexamined Patent Application Publication No. 11-122539 (Patent Reference 2) performs convolution on the pixels of an image-captured image, and generates a predicted-flare. The image-capturing apparatus disclosed in Patent Reference 2 performs convolution processing on all pixels having a brightness that is greater than a certain value (see Patent Reference 2, paragraph 0018). With this, the image-capturing apparatus disclosed in Patent Reference 2 can process a predicted-flare at high speed. Furthermore, the image-capturing apparatus disclosed in Patent Reference 2 generates a predicted-flare using images that are image-captured using three types of exposure times. The image-capturing apparatus disclosed in Patent Reference 2 removes a flare by subtracting the generated predicted-flare from the image that is image-captured using the longest exposure time.

Furthermore, the image-capturing apparatus disclosed in Japanese Unexamined Patent Application Publication No. 2005-167485 (Patent Reference 3) detects pixels having a brightness that is greater than a certain value. The image-capturing apparatus disclosed in Patent Reference 3 generates a predicted-flare using the detected pixels as base points (see Patent Reference 3, FIG. 4, FIG. 6, and FIG. 7).

However, the image-capturing apparatuses disclosed in Patent References 1 through 3 cannot reconstruct a flare-less image when a high-brightness subject such as an extremely strong and bright light source is image-captured. When a high-brightness subject is image-captured the electric charge in pixels around the high-brightness subject are saturated. Thus, with the pixels that are saturated (hereafter referred to as “saturated pixels”), the signals of the dark portion are lost. Accordingly, even when the predicted-flare is subtracted from the image-captured image, the signals from the dark portion cannot be reconstructed. Thus, the image-capturing apparatuses disclosed in Patent References 1 through 3 cannot reconstruct a flare-less image when a high-brightness subject is image-captured.

FIG. 13A through FIG. 13F are diagrams showing the images that are image-processed using the conventional image-capturing apparatuses in Patent References 1 through 3 and the brightness distribution. FIG. 13A is a diagram showing an image when a light source is not present. FIG. 13B is a diagram showing an image when a light source is present and a predicted-flare is not subtracted.

FIG. 13C is a diagram showing an image when a light source is present and a predicted-flare is subtracted.

FIGS. 13D, 13E, and 13F are diagrams showing the brightness distribution in the lateral direction cross-sections of FIGS. 13A, 13B, and 13C, respectively.

As shown in FIG. 13E, brightness is extremely high and pixels are saturated at the periphery of the light source. With this, the signals of an object present in the periphery of the light source are completely lost. For this reason, although the flare is removed in the image from which the predicted-flare is subtracted, there appear areas for which signals cannot be reconstructed, as shown in FIG. 13C. In other words, there is the problem that the image-capturing apparatuses disclosed in Patent References 1 through 3 cannot reconstruct an image when a high-brightness subject is image-captured, that is, when a flare that is sufficiently strong to saturate pixels around a light source and the like occurs.

### SUMMARY OF THE INVENTION

The present invention is conceived to solve the aforementioned conventional problem and has as an object to provide an image-capturing apparatus and an image capturing method that enable the removal of a flare without the loss of signals, even when image-capturing a high-brightness subject such as a light source.

In order to achieve the aforementioned object, the image-capturing apparatus according to the present invention is an image-capturing apparatus including: a solid-state imaging device which generates a first image by image-capturing a subject using a first exposure time; a predicted-flare generating unit which generates a predicted-flare image showing a flare component included in the first image; a subtracting unit which generates a difference image by subtracting the predicted-flare image from the first image; and an amplifying unit which generates an amplified image by amplifying the difference image.

According to this structure, the image-capturing apparatus according to the present invention amplifies a difference image for which the flare has been removed. Accordingly, even when an exposure time which is shorter than the normal exposure time is assumed for the first exposure time, the image-capturing apparatus according to the present invention can generate an image having a brightness that is comparable to that of an image of the normal exposure time. Specifically, the image-capturing apparatus according to the present invention subtracts the predicted-flare from the image of the short exposure time that does not include saturated pixels. Therefore, the image-capturing apparatus according to the present invention can reconstruct the pixels surrounding a high-brightness subject. In other words, even when image-capturing a high-brightness subject, the image-capturing apparatus according to the present invention can remove the flare without the loss of signals.

Furthermore, the solid-state imaging device may further generate a second image by image-capturing the subject using a second exposure time which is longer than the first exposure time, the image-capturing apparatus may further include: an extracting unit which generates a flare area image by extracting an image in a first area in the amplified image; an excluding unit which generates an excluded image by excluding, from the second image, an image in an area in the second image corresponding to the first area; and a synthesizing unit which synthesizes the flare area image and the excluded image, and the first area may be an area in the first image, in which the flare component is included.

According to this structure, the image-capturing apparatus according to the present invention uses the image of the normal exposure time (the second exposure time), aside from the images around the high-brightness subject from which the flare has been removed. Therefore, deterioration of picture quality arising from the amplification of the image of the first exposure time can be kept to a minimum.

Furthermore, the amplifying unit may amplify the difference image according to a ratio between the first exposure time and the second exposure time.

According to this structure, the image-capturing apparatus according to the present invention can make the brightness of the amplified image comparable to the brightness of the second image that is image-captured using the second exposure time.

Furthermore, the extracting unit may generate the flare area image by multiplying the amplified image by a flare area function which normalizes a brightness of the flare component to a value ranging from 0 to 1, the flare area function being inversely proportional to a distance from a center of the flare component.

According to this structure, it is possible to smooth the image-transition at the boundary of the area including the flare and the rest of the areas in the image obtained from the synthesizing by the synthesizing unit.

Furthermore, the excluding unit may generate the excluded image by multiplying the second image by a flare area excluding function obtained by subtracting the flare area function from 1.

According to this structure, it is possible to smoothen image-changing at the boundary of the area including the flare and the rest of the areas in the image obtained from the synthesizing by the synthesizing unit.

Furthermore, the predicted-flare generating unit may include: a barycenter calculating unit which calculates, for each of plural areas into which the first image is divided, a barycenter of first pixels having a brightness greater than a first value; a divisional predicted-flare calculating unit which calculates, for each of the plural areas, a divisional predicted-flare image showing a flare component having the barycenter as a center; and a predicted-flare synthesizing unit which generates the predicted-flare image by synthesizing the respective divisional predicted-flare images calculated for each of the plural areas.

According to this structure, the image-capturing apparatus according to the present invention performs the predicted-flare generation in on a per area basis consisting of the areas into which the first image has been divided. Therefore, processing time can be reduced in comparison to when the predicted-flare generation is performed on a per pixel basis.

Furthermore, the divisional predicted-flare calculating unit may calculate the divisional predicted-flare image for each of the plural areas, by multiplying a predicted-flare function by the number of the first pixels included in the area, the predicted-flare function being inversely proportional to a distance from the barycenter and indicating a brightness of the flare component.

According to this structure, the image-capturing apparatus according to the present invention can easily calculate the brightness of the flare component in each of the areas by using the flare function and the number of first pixels.

Furthermore, the solid-state imaging device may include: plural pixels arranged two-dimensionally, each of which converts incident light into a signal voltage; a voltage judging unit which judges, for each of the plural pixels, whether or not the signal voltage is greater than a reference voltage, the image-capturing apparatus may further include a counter unit which counts the number of the pixels judged by the voltage judging unit as having a signal voltage greater than the reference voltage, and when the number of the pixels counted by the counter unit is greater than a second value, the predicted-flare generating unit may generate the predicted-flare image, the subtracting unit may generate the difference image, and the amplifying unit may generate the amplified image.

According to this structure, the image-capturing apparatus according to the present invention performs the processing for removing a flare only when a high-brightness subject is included in the image-captured image.

Furthermore, the solid-state imaging device may include an exposure time adjustment unit which shortens the first exposure time when the number of the pixels counted by the counter unit is greater than the second value.

According to this structure, the image-capturing apparatus according to the present invention can automatically adjust the first exposure time so that saturated pixels are not included in an image to be image captured using the first exposure time.

Furthermore, the solid-state imaging device may further include a signal generating unit which generates a first signal when the number of the pixels counted by the counter unit is greater than the second value, the image-capturing apparatus may further include a first exposure time calculating unit which calculates, based on the first signal, the first exposure time shortened by the exposure time adjusting unit, and the amplifying unit may amplify the difference image according to a ratio between the first exposure time calculated by the first exposure time calculating unit and the second exposure time.

According to this structure, the image-capturing apparatus according to the present invention can adjust the gain of the amplifying unit based on the first signal generated by the solid-state imaging device.

Furthermore, the solid-state imaging device may include: plural pixels arranged two-dimensionally, each of which converts incident light into signal voltage; a correlated double sampling circuit which performs correlated double sampling on the signal voltage for the first exposure time and the signal voltage for the second exposure time, and holds a signal for the first exposure time and a signal for the second exposure time; a first output unit which generates the first image by amplifying the signal for the first exposure time held in the correlated double sampling circuit, and to output the generated first image; and a second output unit which generates the second image by amplifying the signal for the second exposure time held in the correlated double sampling circuit, and to output the generated second image.

According to this structure, the image-capturing apparatus according to the present invention can simultaneously output images of two exposure times.

Furthermore, the camera according to the present invention includes a solid-state imaging device which generates a first image by image-capturing a subject using a first exposure time; a predicted-flare generating unit which generates a predicted-flare image showing a flare component included in the first image; a subtracting unit which generates a difference image by subtracting the predicted-flare Image from the first image; and an amplifying unit which generates an amplified image by amplifying the difference image.

According to this structure, the camera according to the present invention includes an image-capturing apparatus that can remove the flare without the loss of signals, even when image-capturing a high-brightness subject. Therefore, the camera according to the present invention can image-capture an image for which a flare has been removed, without the loss of signals, even when image-capturing a high-brightness subject.

Furthermore, the vehicle according to the present invention includes a solid-state imaging device which generates a first image by image-capturing a subject using a first exposure time; a predicted-flare generating unit which generates a predicted-flare image showing a flare component included in the first image; a subtracting unit which generates a difference image by subtracting the predicted-flare image from the first image; and an amplifying unit which generates an amplified image by amplifying the difference image.

According to this structure, the vehicle according to the present invention includes a camera that can image-capture an image for which a flare has been removed without the loss of signals, even when image-capturing a high-brightness subject. Therefore, the vehicle according to the present invention can display, to the driver, an image in which the signals around the high-brightness subject are not lost. Thus, the vehicle according to the present invention can improve safety during driving.

Furthermore, the image-capturing method according to the present invention is an image-capturing method used in an image-capturing apparatus including a solid-state imaging device which image-captures an image of a subject using a first exposure time and generates a first image, the image-capturing method includes: generating a predicted-flare image showing a flare component included in the first image; generating a difference image by subtracting the predicted-flare image from the first image; and generating an amplified image by amplifying the difference image.

Accordingly, in the image-capturing method according to the present invention, a difference image for which the flare has been removed is amplified. Accordingly, even when an exposure time which is shorter than the normal exposure time is assumed for the first exposure time, the image-capturing method according to the present invention enables the generation an image having a brightness that is comparable to that of an image of the normal exposure time. Specifically, in the image-capturing method according to the present invention, the predicted-flare is subtracted from the image of the short exposure time that does not include saturated pixels. Therefore, the image-capturing method according to the present invention enables the reconstruction of the pixels surrounding a high-brightness subject. In other words, even when image-capturing a high-brightness subject, the image-capturing method according to the present invention enables the removal of the flare without the loss of signals.

It should be noted that the present invention can be implemented, not only as an image-capturing apparatus such as that described herein, but also as a method having, as steps, the characteristic processing units included in such image-capturing apparatus, or a program causing a computer to execute such characteristic steps. In addition, it goes without saying that such a program can be distributed via a recording medium such as a CD-ROM and via a transmitting medium such as the Internet.

As described above, the present invention can provide an image-capturing apparatus and an image capturing method that enable the removal of a flare without the loss of signals, even when image-capturing a high-brightness subject such as a light source.

### FURTHER INFORMATION ABOUT TECHNICAL BACKGROUND TO THIS APPLICATION

The disclosure of Japanese Patent Application No. 2007-317635 filed on Dec. 7, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a perspective view showing the external appearance of a vehicle equipped with the image-capturing apparatus according to an embodiment of the present invention;

FIG. 2 is diagram showing the configuration the image-capturing apparatus according to an embodiment of the present invention;

FIG. 3 is a flowchart showing the flow of the image-capturing operation performed by the image-capturing apparatus according to an embodiment of the present invention;

FIG. 4 is cross-section view showing the structure of the imaging device according to an embodiment of the present invention;

FIG. 5A is diagram showing an example of the short-time exposure image according to an embodiment of the present invention;

FIG. 5B is diagram showing an example of the long-time exposure image according to an embodiment of the present invention;

FIG. 5C is diagram showing the brightness distribution of the short-time exposure image according to an embodiment of the present invention;

FIG. 5D is diagram showing the brightness distribution of the long-time exposure image according to an embodiment of the present invention;

FIG. 6 is a flowchart showing the flow of the predicted-flare generation performed by the predicted-flare generating unit according to an embodiment of the present invention;

FIG. 7 is a diagram for describing the predicted-flare generation performed by the predicted-flare generating unit according to an embodiment of the present invention;

FIG. 8A is a diagram showing an image sample of the long-time exposure image;

FIG. 8B is a diagram showing an image sample when the predicted-flare is not subtracted, and only amplification is performed;

FIG. 8C is a diagram showing and example of the image on which the subtraction of the predicted-flare and the amplification by the image-capturing apparatus 100 have been performed;

FIG. 9 is a diagram for describing the processing performed by the flare area excluding unit and the image synthesizing unit according to an embodiment of the present invention;

FIG. 10 is a diagram showing the configuration of the imaging device according to an embodiment of the present invention;

FIG. 11 is a diagram showing the control of the electronic shutter in the imaging device according to an embodiment of the present invention;

FIG. 12 is a timing chart showing the operation of the imaging device according to an embodiment of the present invention;

FIG. 13A is a diagram showing an image in a conventional image-capturing apparatus when a light source is not present;

FIG. 13B is a diagram showing an image in a conventional image-capturing apparatus when a light source is present and a predicted-flare is not subtracted;

FIG. 13C is a diagram showing an image in a conventional image-capturing apparatus when a light source is present and a predicted-flare is subtracted;

FIG. 13D is a diagram showing the brightness distribution in a conventional image-capturing apparatus when a light source is not present;

FIG. 13E is a diagram showing the brightness distribution in a conventional image-capturing apparatus when a light source is present and a predicted-flare is not subtracted;

FIG. 13F is a diagram showing an image in a conventional image-capturing apparatus when a light source is present and a predicted-flare is subtracted.

### DESCRIPTION OF THE PREFERRED EMBODIMENT(S)

Hereinafter, an embodiment of the present invention shall be described with reference to the Drawings.

First, the configuration of the image-capturing apparatus according to an embodiment of the present invention shall be described.

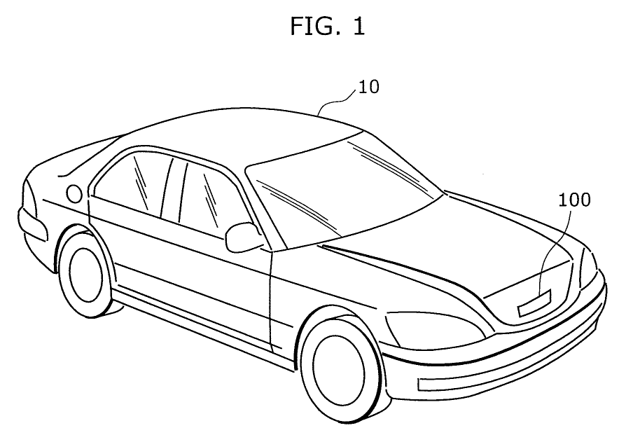

FIG. 1 is a perspective view showing the external appearance of a vehicle equipped with the image-capturing apparatus according to an embodiment of the present invention.

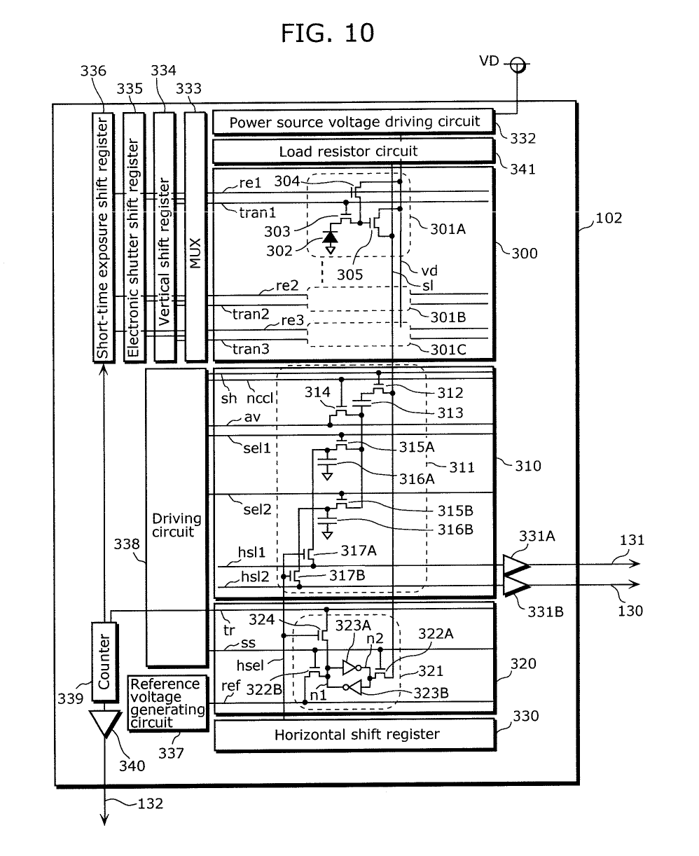

The vehicle 10 shown in FIG. 10 is a typical automobile. The vehicle 10 includes an image-capturing apparatus 100 in the front face of the vehicle 10. It should be noted that the vehicle 10 may include the image-capturing apparatus 100 in the rear face or side faces of the vehicle 10. Furthermore, the vehicle 10 may also include plural image-capturing apparatuses 100.

The image-capturing apparatus 100 is used for driver's visibility assistance. The image-capturing apparatus 100 image-captures the surroundings of the vehicle 10. The images that are image-captured by the image-capturing apparatus 100 are displayed on a display unit of an in-vehicle monitor in the vehicle 10.

The image-capturing apparatus 100 according to an embodiment of the present invention removes a flare from an image that is image-captured using a short exposure time, which does not include pixels saturated due to the light of a high-brightness subject such as a light source. With this, even when image-capturing a high-brightness subject, the image-capturing apparatus 100 can generate an image from which the flare has been removed, without the loss of signals. As such, even when a person or object is present near the headlight of an oncoming vehicle or a nearby vehicle at night and so on, information is not lost due to flares. With this, the driver can verify the presence of the person or object near the headlight, through the monitor, and so on, and thus safety is improved.

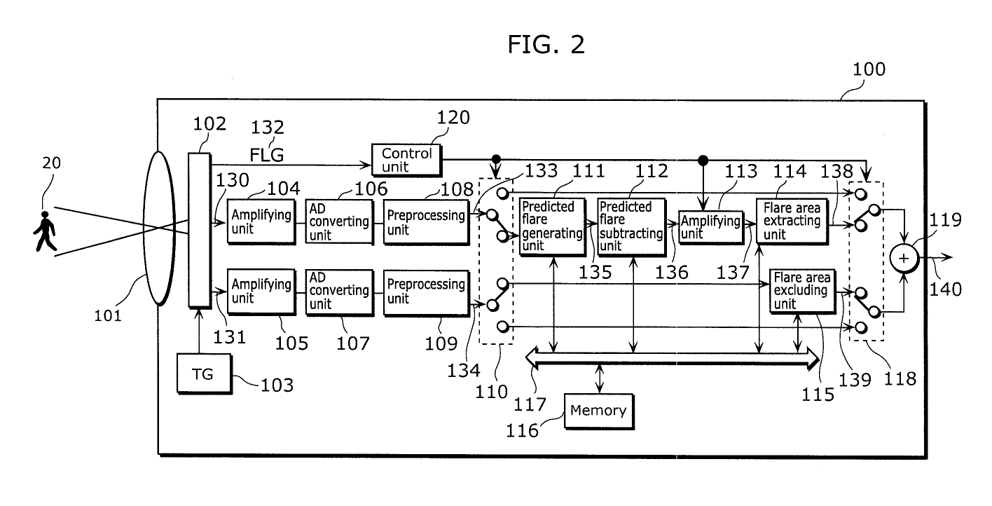

FIG. 2 is a diagram showing the configuration of the image-capturing apparatus 100.

As shown in FIG. 2, the image-capturing apparatus 100 includes an objective lens 101, an imaging device 102, a timing generating unit (TG) 103, an amplifying units 104 and 105, an AD converting units 106 and 107, preprocessing units 108 and 109, a switch 110, a predicted-flare generating unit 111, a predicted-flare subtracting unit 112, an amplifying unit 113, a flare area extracting unit 114, a flare area excluding unit 115, a memory 116, a database 117, a switch 118, an image synthesizing unit 119, and a control unit 120.

The objective lens 101 gathers light from a subject 20 to the imaging device 102.

The imaging device 102 is a solid-state imaging device such as a CMOS image sensor. It should be noted that the imaging device 102 may also be a CCD image sensor, or the like. Furthermore, the imaging device 102 is a semiconductor integrated circuit configured, for example, as a single chip.

The imaging device 102 image-captures the light gathered by the objective lens 101. Specifically, the imaging device 102 converts the light into an electric signal (analog signal) and outputs the electric signal. Furthermore, the imaging device 102 generates a short-time exposure signal 130 which is an analog signal of an image that is image-captured using a short exposure time, and a long-time exposure signal 131 which is an analog signal of an image that is image-captured using a normal long exposure time. The imaging device 102 outputs the short-time exposure signal 130 to the amplifying unit 104 and the long-time exposure signal 131 to the amplifying unit 105.

Furthermore, the imaging device 102 generates an FLG signal 132 indicating whether or not a high-brightness subject such as a light source is included in the image-captured image and outputs the FLG signal 132 to the control 120. Specifically, the FLG signal 132 is a signal indicating whether or not there are saturated pixels greater than a specific number for the long-time exposure signal 131. For example, when active, the FLG signal 132 indicates that a high-brightness subject is included in the image-captured image and, when inactive, the FLG signal 132 indicates that a high-brightness subject is not included in the image-captured image.

The timing generating unit 103 generates a signal which controls the timing for driving the imaging device 102.

The amplifying unit 104 amplifies the short-time exposure signal 130. The amplifying unit 105 amplifies the long-time exposure signal 131.

The AD converting unit 106 converts the short-time exposure signal 130 amplified by the amplifying unit 104, into a digital signal. The AD converting unit 107 converts the long-time exposure signal 131 amplified by the amplifying unit 105, into a digital signal

The preprocessing unit 108 performs preprocessing such as pixel compensation processing, color processing, and gamma processing on the digital signal obtained from the conversion by the AD converting unit 106, and generates a short-time exposure image 133. The preprocessing unit 109 performs preprocessing such as pixel compensation processing, color processing, and gamma processing on the digital signal obtained from the conversion by the AD converting unit 107, and generates a long-time exposure image 134.

The switches 110 and 118 are switches for selecting whether or not to perform processing for removing a flare.

Specifically, the switches 110 and 118 select whether to output the short-time exposure image 133 generated by the preprocessing unit 108 to the image synthesizing unit 119 directly or to the image synthesizing unit 119 via the predicted-flare generation unit 111, the predicated flare subtracting unit 112, the amplifying unit 113, and the flare area extracting unit 114. Furthermore, the switches 110 and 118 select whether to output the long-time exposure image 134 generated by the preprocessing unit 109 to the image synthesizing unit 119 directly or to the image synthesizing unit 119 via the flare area excluding unit 115.

The switches 110 and 118 output the short-time exposure image 133 and the long-time exposure image 134 directly to the image synthesizing unit 119 when the processing for removing a flare is not to be performed. The switches 110 and 118 output the short-time exposure image 133 to the predicted-flare generating unit 111, and the long-time exposure image 134 to the flare area excluding unit 115 when the processing for removing a flare is to be performed.

The predicted-flare generating unit 111 generates a predicted-flare 135 from the short-time exposure image 133. The predicted-flare 135 is an image showing the flare component included in the short-time exposure image 133, and is an image obtained by hypothetically calculating the flare component. Here, flare component refers to a component of light arising due to multiple reflections of light generated from a high-brightness subject, and is a component of light appearing around the high-brightness subject.

The predicted-flare subtracting unit 112 generates an image 136 by subtracting the predicted-flare 135 from the short-time exposure image 133.

The amplifying unit 113 generates an image 137 by amplifying the image 136 using a gain that is in accordance with the exposure time ratio between the short-time exposure image 133 and the long-time exposure image 134.

The flare area extracting unit 114 extracts, from the image 137, an image 138 which is the flare area. The flare area is an area in the short-time exposure image 133, in which the flare component is included. In other words, the flare area is the area in which the component of light arising due to multiple reflections of light generated from a high-brightness subject is included, and is the area around the high-brightness subject.

The flare area excluding unit 115 generates an image 139 by excluding the image of the flare area from the long-time exposure image 134.

The memory 116 is a storage unit which holds the image generated by the predicted-flare generating unit 111, the predicted-flare subtracting unit 112, the flare area extracting unit 114, and the flare area excluding unit 115, as well as data in mid-processing, and so on.

The data bus 117 is a bus used in data transfer between the memory 116 and the predicted-flare generating unit 111, predicted-flare subtracting unit 112, flare area extracting unit 114, and flare area excluding unit 115.

The image synthesizing unit 119 generates an image 140 by synthesizing the short-time exposure image 133 and the long-time exposure image 134, when the processing for removing the flare is not to be performed. Furthermore, the image synthesizing unit 119 generates the image 140 by synthesizing the image 138 and the image 139, when the processing for removing the flare has been performed.

The image 140 generated by the image synthesizing unit 114 is displayed on the display unit of an in-vehicle monitor, and the like, in the vehicle 10.

The control unit 120 controls the selection by the switches 110 and 118 based on the FLG signal 132. Specifically, when the FLG signal 132 is inactive, the control unit 120 controls the switches 110 and 118 so that the processing for removing the flare is not performed. When the FLG signal 132 is active, the control unit 120 controls the switches 110 and 118 so that the processing for removing the flare is performed.

Furthermore, the control unit 120 calculates the ratio between the short exposure time and the long exposure time and notifies the calculated ratio to the amplifying unit 113, based on the FLG signal 132.

Next, the operation of the image-capturing apparatus 100 shall be described.

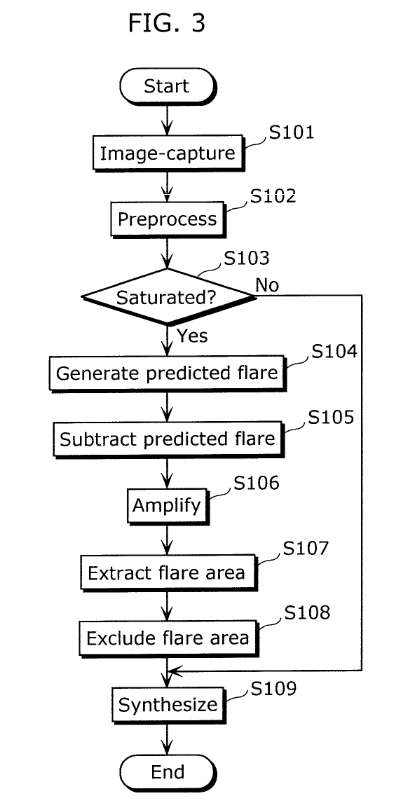

FIG. 3 is a flowchart showing the flow of the image-capturing operation performed by the image-capturing apparatus 100.

First, the imaging device 102 image-captures the subject 20 (S101).

Specifically, light from the subject 20 is gathered via the objective lens 101 and incidents to the imaging device 102.

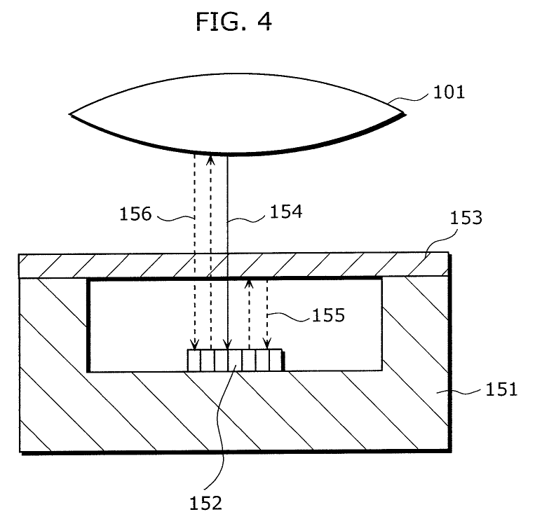

FIG. 4 is a cross-section view showing the structure of the imaging device 102. As shown in FIG. 4, the imaging device 102 includes a semiconductor package 151, a semiconductor chip 152, and a cover glass 153.

The semiconductor package 151 has an aperture inside of which the semiconductor chip 152 is located. The semiconductor chip 152 is an image sensor.

The cover glass is located on the aperture-side of the semiconductor package 151.

Incident light 154 gathered by the objective lens 101 passes through the cover glass 153 and incidents to the semiconductor chip 152.

When the subject 20 is a strong light source, the incident light 154 reflects off of the surface of semiconductor chip 152. The incident light 154 is reflected by the cover glass 153, the objective lens 101, and so on. Multi-reflected light 155 reflected by the cover glass 153 re-enters the semiconductor chip 152. Furthermore, multi-reflected light 156 reflected by the objective lens 101 re-enters the semiconductor chip 152. The multi-reflected lights 155 and 156 become flares, and the image-captured image will no longer be an image which accurately depicts the subject 20. In particular, when the flare is strong, subject information around the light source is lost.

The imaging device 102 makes the FLG signal 132 active when such a strong light enters.

Furthermore, the imaging device 102 outputs the short-time exposure signal 130 for which the short exposure time is used in image-capturing so that pixels are not saturated due to a flare, and a long-time exposure signal 131 for which the normal long exposure time is used in image-capturing. Note that the detailed configuration and operation of the imaging device 102 shall be described later.

After being amplified by the amplifying unit 104, the short-time exposure signal 130 is converted into a digital signal by the AD converting unit 106. Furthermore, after being amplified by the amplifying unit 105, the long-time exposure signal 131 is converted into a digital signal by the AD converting unit 107.

It should be noted that, although the processing performed by the amplifying units 104 and 105 and the AD converting units 106 and 107 are performed outside of the imaging device 102, such processing may be performed inside the imaging device 102. Specifically, the amplifying units 104 and 105 may be replaced by a column amplifier inside the imaging device 102, and the AD conversion units 106 and 107 may be replaced by a column AD converter inside the imaging device 102. In other words, digitalization may be performed inside the imaging device 102 as in a commonly known digital output imaging device.

The preprocessing unit 108 performs digital image processing on the digital signal obtained from the conversion by the AD converting unit 106, and generates the short-time exposure image 133. The preprocessing unit 109 performs digital image processing on the digital signal obtained from the conversion by the AD converting unit 107, and generates the long-time exposure image 134 (S102).

Specifically, the preprocessing units 108 and 109 perform pixel compensation when the imaging device 102 is a single-plate imaging device. A single-plate imaging device includes a color filter having a primary color matrix such as a Bayer matrix, or another color filter such as color filter having a complimentary color matrix. Furthermore, the preprocessing units 108 and 109 perform OB (black level) difference processing to calculate respective differences obtained by deducting, from each pixel, the average value of the pixel set covered by a light-shielding film.

The preprocessing units 108 and 109 include several lines of line memories for performing pixel compensation. The number of lines of the line memories is determined depending on the wideness of the area of the pixel information to be referenced at the time of pixel compensation. Furthermore, the preprocessing units 108 and 109 perform color temperature correction of the lighting environment, and so on, using white balance and the like. Furthermore, the preprocessing units 108 and 109 perform matrix arithmetic, and so on, which is a correction to bring the transmissivity of color filter closer to the ideal transmissivity. Since, collective linear processing is possible for processing aside from the usual pixel compensation, the preprocessing units 108 and 109 perform, in one matrix arithmetic, processing other than the usual pixel compensation.

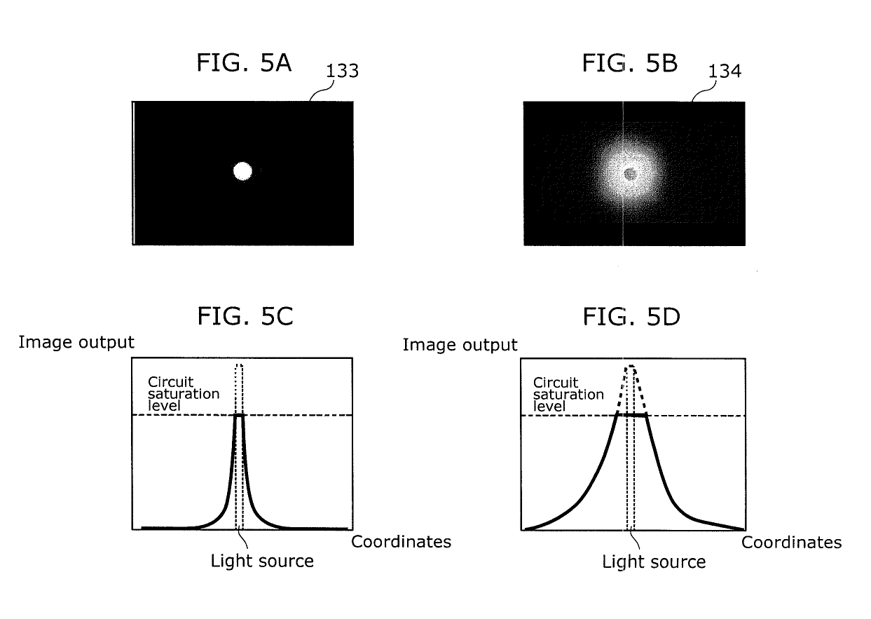

FIGS. 5A through 5D are diagrams showing an example of the short-time exposure image 133 and the long-time exposure image 134, and brightness distributions. FIG. 5A is a diagram showing an image sample of the short-time exposure image 133, and FIG. 5B is a diagram showing an image sample of the long-time exposure image 134. FIG. 5C is a diagram showing the brightness distribution for the short-time exposure image 133 in FIG. 5A, and FIG. 5D is a diagram showing the brightness distribution for the long-time exposure image 134 in FIG. 5B.

As shown in FIGS. 5A through 5D, in the short-time exposure image 133 and the long-time exposure image 134, a scattered reflection component which is inversely proportional to the distance from the central light source spreads out as a flare.

Furthermore, as shown in FIGS. 5A and 5C, although its brightness is lower compared to the brightness of the light source, a flare component is present in the short-time exposure image 133.

On the other hand, FIGS. 5B and 5D show that, since accumulation time is long, pixel output at the periphery near the light source exceeds circuit saturation level, in the long-time exposure image 134. With this, assuming that a person or an object is present at the periphery of the light source, the signal of the person or object is lost due to the saturating flare.

Next, the control unit 120 judges whether or not saturated pixels greater than a specific number are included in the long-time exposure image 134, based on the FLG signal 132 (S103).

When saturated pixels greater than the specific number are included in the long-time exposure image 134, that is, when a high-brightness subject is image-captured (Yes in S103), the control unit 120 inputs the short-time exposure image 133 to the predicted-flare generating unit 111 and inputs the long-time exposure image 134 to the flare area excluding unit 115, by controlling the switches 110 and 118.

The predicted-flare generating unit 111 generates the predicted-flare 135 from the short-time exposure image 133 (S104).

Hereinafter, the predicted-flare generation (S104) shall be described in detail.

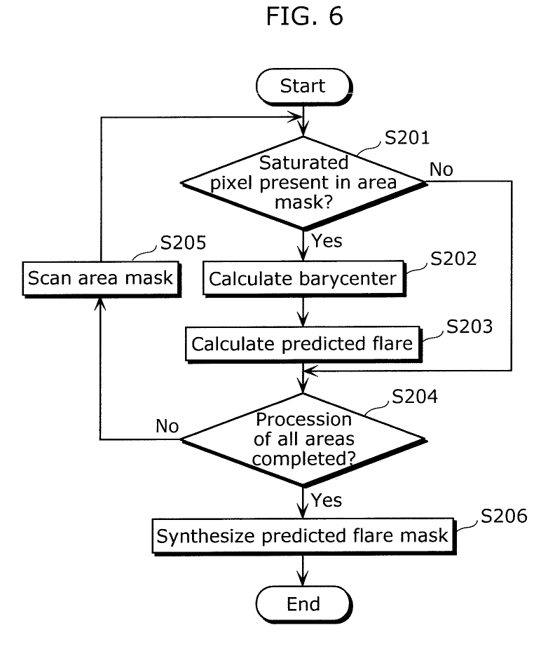

FIG. 6 is a flowchart showing the flow of the predicted-flare generation performed by the predicted-flare generating unit 111.

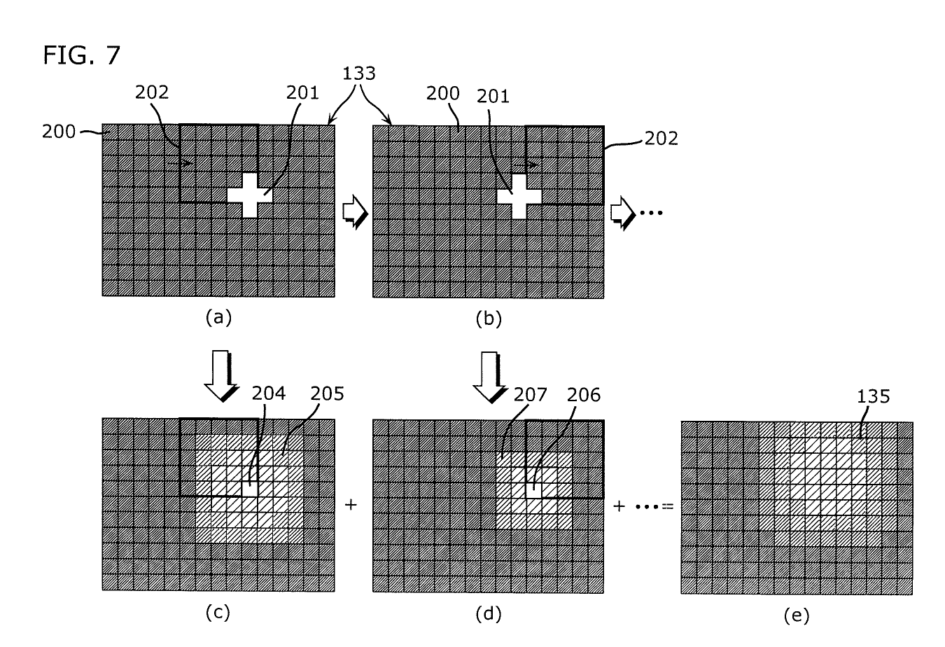

FIG. 7 is a diagram for describing the predicted-flare generation performed by the predicted-flare generating unit 111. As shown in FIG. 7, the short-time exposure image 133 includes pixels 200 which are pixels having a brightness equal to or less than the specific value, and pixels 201 which are pixels having a brightness greater than the specific value. The pixels 201 are pixels corresponding to the saturated pixels in the long-time exposure image 134, and the pixels 200 are pixels corresponding to the pixels other than the saturated pixels in the long-time exposure image 134.

First, the predicted-flare generating unit 111 generates a predicted-flare on an area mask 202 basis. More specifically, the predicted-flare generating unit 111 generates a predicted-flare which is a hypothetical flare component, for each of plural areas into which the short-time exposure image 133 is divided.

For example, the area mask 202 is 5×5 pixels in size, as shown in FIG. 7. It should be noted that the area mask 202 may be 10×10 pixels in size, and so on. Furthermore, the area mask 202 need not have a one-is-to-one vertical and horizontal ratio. Although enlarging the size of the area mask 202 can further reduce the processing amount for the predicted-flare generating unit 111, the accuracy of the generated predicted-flare is reduced.

The predicted-flare generating unit 111 scans the short-time exposure image 133 on an area mask 202 size basis.

Hereinafter, the generation of a predicted-flare by the predicted-flare generating unit 111 with respect to an area included in the area mask 202 shown in (a) in FIG. 7 shall be described.

First, the predicted-flare generating unit 111 judges whether or not pixels 201 are present in the area mask 202 (S201). When pixels 201 are present (Yes in S201), the predicted-flare generating unit 111 calculates the barycenter of the pixels 201 included in the area mask 202, using mathematical expressions 1 and 2.

$$\begin{matrix}{G}_{x} = \frac{{\sum }_{x = 1}^{n} ( {M}_{x} \cdot x )}{{\sum }_{x = 1}^{n} {M}_{x}} & [ Mathematical expression 1 ] \\ {G}_{y} = \frac{{\sum }_{y = 1}^{n} ( {M}_{y} \cdot y )}{{\sum }_{y = 1}^{n} {M}_{y}} & [ Mathematical expression 2 ]\end{matrix}$$

Here, Gx is the x-coordinate of the barycenter, Gy is the y-coordinate of the barycenter, Mx is brightness of the x-coordinate, My is the brightness of the y-coordinate, n is the size of the area mask 202. It should be noted that although the predicted-flare generating unit 111 calculates the barycenter from the coordinates and brightness of all the pixels inside the area mask 202 as shown in mathematical expressions 1 and 2, the barycenter may be calculated from the coordinates and brightness of the pixels 201 in order to reduce the processing amount. Furthermore, in order to further reduce the processing amount, the predicted-flare generating unit 111 may calculate the barycenter only from the coordinates of the pixels 201.

(c) in FIG. 7 is a diagram showing the predicted-flare generated with respect to the area included in the area mask 202 shown in (a) in FIG. 7.

The predicted-flare generating unit 111 calculates a barycenter 204 shown in (c) in FIG. 7, using mathematical expressions 1 and 2.

The predicted-flare generating unit 111 calculates a predicted-flare 205 using a predicted-flare function, with the calculated barycenter 204 as the center (S203). The predicted-flare function is a function indicating the brightness of the flare component in each pixel. Furthermore, the predicted-flare function is a function that is inversely proportional to the distance from the barycenter 204.

Here, the shape of the flare changes depending on the optical characteristics of the optical lens such as the objective lens 101, the microlens prepared above the image-capturing lens 102, and the cover glass 153 protecting the semiconductor chip 152. Specifically, the optical characteristics are transmissivity, reflectivity, the scattering of light, and so on. As such, the derivation of the predicted-flare function requires adjustments such as in experimental calculation.

As shown in FIG. 4, a flare is a phenomenon occurring due to light reflecting off the surface of the semiconductor chip 152 and re-reflecting off the cover glass 153. Therefore, in a strict sense, the predicted-flare function can be represented by mathematical expression 3.

I_{—}D=I_{—}I·(R1·R2)^{N} [Mathematical expression 3]

Here, I_D is the brightness of light inputted to a specific pixel; I_I is the brightness of light incident from a light source and the like, R₁ is the reflectivity of the semiconductor chip 152; R2 is the reflectivity of the cover glass 153; and N is the number of times of multiple reflections.

Here, assuming that light is scattered for each reflection and that light moves away from the barycenter 204 by one pixel for each reflection, a distance r from the barycenter 204 up to the pixel can be approximated as distance r=N. Therefore, the predicted-flare function can be represented by mathematical expression 4.

I_{—}D=I_{—}I·(R1·R2)^{r} [Mathematical expression 4]

Since reflectivity R1 and R2 are values less than 1, the brightness of light inputted to a pixel due to the flare is inversely proportional to the distance from the barycenter 204.

It should be noted that although in the strict sense it is preferable that the predicted-flare generating unit 111 generates the predicted-flare using the formula represented in mathematical expression 4, a formula which is a simplification of the formula in mathematical expression 4 may be used in order to reduce the processing amount. More specifically, it is sufficient for the predicted-flare generating unit 111 to use the predicted-flare function which is inversely proportional to the distance from the barycenter 204.

Furthermore, the predicted-flare generating unit 111 may use a formula which is a modification of the mathematical expression 4 depending on the shape of the optical lens, the microlens, the cover glass, and so on. Furthermore, the predicted-flare generating unit 111 may use a formula which is a modification of the mathematical expression 4 depending on the exposure time of short-time exposure image 133, or the exposure time ratio between the short-time exposure image 133 and the long-time exposure image 134.

The predicted-flare generating unit 111 multiplies the predicted-flare calculated using the mathematical expression 4, by the number of the pixels 201 included inside the area mask 202. For example, in the example in (a) in FIG. 7, since the number of saturated pixels is 3, the predicted-flare generating unit 111 calculates the predicted-flare 205 shown in (c) in FIG. 7 by multiplying, by three, the predicted-flare calculated using the mathematical expression 4.

Since the predicted-flare generation (S201 to S203) is not yet completed for all the areas of the short-time exposure image 133, the predicted-flare generating unit 111 moves the area mask 202 (S205). For example, as shown in (b) in FIG. 7, the predicted-flare generating unit 111 moves the area mask 202 in the lateral direction.

The predicted-flare generating unit 111 performs the processing in steps S201 to S203 on the area to which the area mask 202 has been moved.

For example, in the example shown in (b) in FIG. 7, since pixels 201 are present inside the area mask 202 (Yes in S201), the predicted-flare generating unit 111 calculates the barycenter 206 shown in (d) in FIG. 7 (S202), and calculates the predicted-flare 207 (S203).

Hereinafter, the predicted-flare generating unit 111 performs the processing in steps S201 to S203 on all the areas of the short-time exposure image 133, on an area mask 202 basis.

Furthermore, when a saturated pixel does not exist inside the area mask 202 (No in S201), the predicted-flare generating unit 111 does not perform the predicted-flare calculation (S202 and S203) and moves the area mask 202 (S205).

When the predicted-flare generation (S201 to S203) is completed for all the areas of the short-time exposure image 133 (Yes in S204), the predicted-flare generating unit 111 synthesizes the predicted-flares 205 and 207 that were calculated on an area mask 202 basis. The predicted-flare generating unit 111 generates, for example, a predicted-flare 135 shown in (e) in FIG. 7, by synthesizing the predicted-flares 205 and 207 that were calculated on an area mask 202 basis.

As described above, the predicted-flare generating unit 111 performs the predicted-flare generation (S201 to S203) on an area mask 202 basis. Therefore, processing speed can be improved compared to generating a predicted-flare on a per pixel basis.

Description is continued again with reference to FIG. 3. After the predicted-flare generation (S104), the predicted-flare subtracting unit 112 generates the image 136 by subtracting the predicted-flare 135 generated by the predicted-flare generating unit 111, from the short-time exposure image 133 (S105).

Next, the amplifying unit 113 generates the image 137 by amplifying the image 136 by a gain that is in accordance with the exposure time ratio between the short-time exposure image 133 and the long-time exposure image 134 (S106). With this, the brightness of the image 137 generated from the short-time exposure image 133 of a short exposure time attains a level that is comparable to the brightness of the image 136 generated from the long-time exposure image 134 of the normal exposure time. For example, by multiplying the brightness values of each pixel by the ratio between the long exposure time (normal exposure time) and the short exposure time, the brightness of the image 137 attains a level that is comparable to the brightness of the long-time exposure image 134. It should be noted that the amplification method used by the amplifying unit 113 may be a linear amplification, and may also be a logarithmic amplification based on brightness.

Furthermore, the gain used by the amplifying unit 113 is specified by the control unit 120. The control unit 120 calculates the gain based on the FLG signal 132. Note that the calculation of the gain performed by the control unit 120 shall be described later.

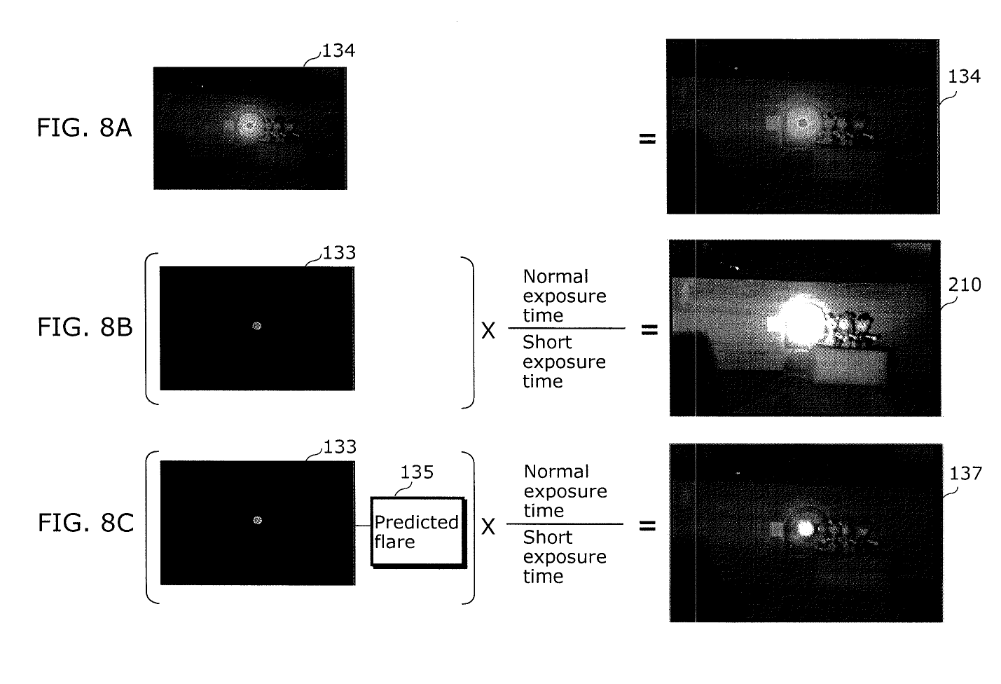

FIGS. 8A through 8C are diagrams for describing the processing performed by the predicted-flare subtracting unit 112 and the amplifying unit 113.

FIG. 8C is a diagram showing an example of the image 137 on which the subtraction of the predicted-flare 135 and the amplification by the image-capturing apparatus 100 have been performed. Furthermore, FIGS. 8A and 8B are diagrams for comparison. FIG. 8A is a diagram showing an image sample of the long-time exposure image 134. FIG. 8B is a diagram showing an image sample when the predicted-flare 135 is not subtracted and only amplification is performed.

In the long-time exposure image 134 and an image 210 shown in FIGS. 8A and 8B, respectively, a part of an object cannot be seen since the pixels around the light source are saturated.

On the other hand, as shown in FIG. 8C in the image 137 on which the subtraction of the predicted-flare 135 and the amplification have been performed, the image around the light source has been restored. Furthermore, the amplified image 137 has a brightness level that is comparable to that of the long-time exposure image 134.

Next, the flare area extracting unit 114 extracts the image 138 from the image 137 (S107). Furthermore, the flare area excluding unit 115 generates an image 139 by excluding the image of the flare area from the long-time exposure image 134 (S108).

Next, the image synthesizing unit 119 generates the image 140 by synthesizing the image 138 and the image 139 (S109).

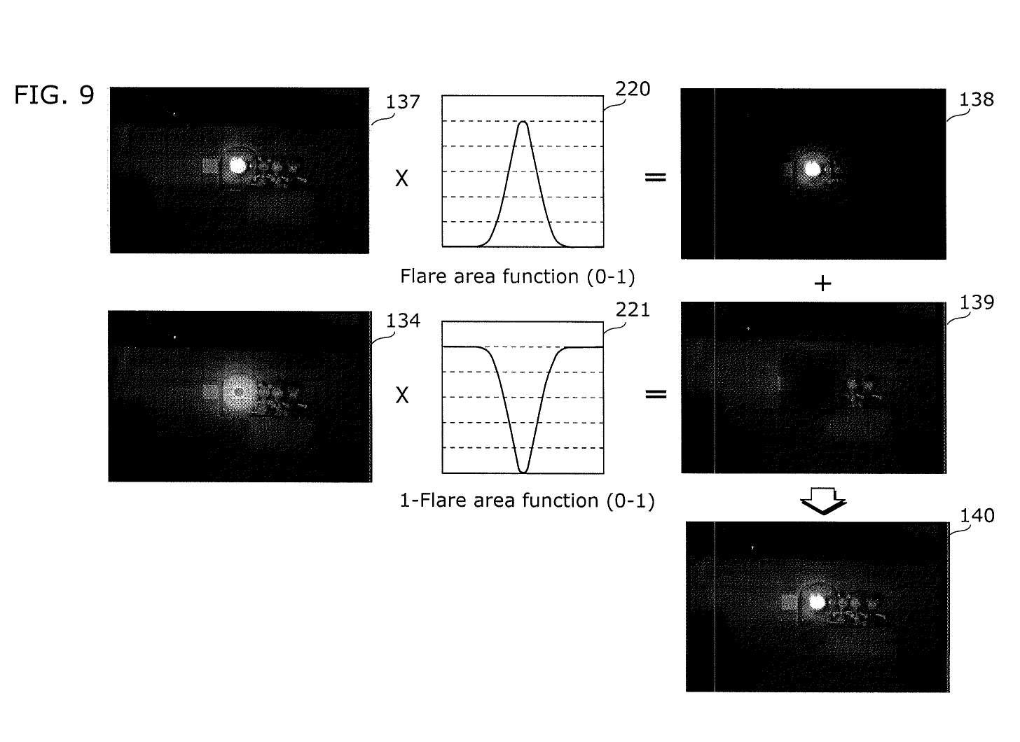

FIG. 9 is a diagram for describing the processing performed by the flare area excluding unit 115 and the image synthesizing unit 119.

As shown in FIG. 9, the flare area extracting unit 114 generates the image 138 by multiplying the image 137 with a flare area function 220. The flare area function 220 is a function obtained by normalizing the predicted-flare function generated by the predicted-flare generating unit 111 to a value from 0 to 1. With this, the flare area extracting unit 114 generates an image 138 for which only the signals of the flare area (area around the light source) has been extracted.

It should be noted that the flare area function 220 may be a function obtained by correcting the predicted-flare function generated by the predicted-flare generating unit 111 then normalizing the corrected predicted-flare function to a value from 0 to 1. Furthermore, the flare area function 220 may be a function that is different from the predicted-flare function generated by the predicted-flare generating unit 111, and may be a function obtained by normalizing the brightness of the flare component in each pixel to a value from 0 to 1.

Furthermore, the flare area excluding unit 115 generates the image 139 by multiplying the long-time exposure image 134 by a flare area excluding function 221. The flare area excluding function 221 is a function obtained by subtracting the flare area function 220 from 1, and has a value from 0 to 1. With this, the flare area excluding unit 115 generates the image 139 for which the signal of the flare area has been excluded from the long-time exposure image 134.

Here, although the computation of decimal numbers is difficult using hardware, decimal number computation may be performed in the same manner as with common hardware computations, by computing after multiplication by the power-of-two and then, in the end, dividing by the power-of-two.

The image synthesizing unit 119 generates the flare-less image 140 by synthesizing the image 138 and the image 139.

On the other hand, when a high-brightness subject is not present and saturated pixels are not included in the long-time exposure image 134 (No in S103), the control unit 120 inputs the short-time exposure image 133 and the long-time exposure image 134 to the image synthesizing unit 119, by controlling the switches 110 and 118.

Next, the image synthesizing unit 119 generates the image 140 by synthesizing the short-time exposure image 133 and the long-time exposure image 134 (S109). With this, the image-capturing apparatus 100 can widen the dynamic range of the image 140. Furthermore, the image-capturing apparatus 100 can automatically select between two modes, namely, a flare removing signal processing mode and a dynamic range widening signal processing mode.

It should be noted that the image-capturing apparatus 100 may include a delaying device to be inserted in the path of the short-time exposure image 133 or long-time exposure image 134 to the image synthesizing unit 119. With this, it becomes possible to match up the frame speeds of the short-time exposure image 133 and the long-time exposure image 134.

With this, the image-capturing apparatus 100 according to an embodiment of the present invention can generate the image 140 for which the effects of the flare have been reduced.

Furthermore, the image-capturing apparatus 100 generates the predicted-flare 135 using the short-time exposure image 133, and subtracts the predicted-flare 135 from the short-time exposure image 133. As shown in FIGS. 5A through 5D, even when image signals are saturated by the flare in the long-time exposure image 134, the image signals are not saturated in the short-time exposure image 133 and thus the image-capturing apparatus 100 can reconstruct the information of the image signals in the flare area.

Furthermore, in the case where predicted-flare generation is performed on a per pixel basis as in the conventional image-capturing apparatus, when many high-brightness subjects such as a light source are present and there are many saturated pixels, processing time becomes longer in proportion to the number of saturated pixels. On the other hand, the image-capturing apparatus 100 performs predicted-flare generation on an area mask 202 basis. With this, it is possible to suppress the increase of processing time due to the increase in the number of saturated pixels (pixels 201).

Furthermore, the image-capturing apparatus 100 amplifies the image 136 obtained by removing the flare from the short-time exposure image 133. With this, the brightness of the short-time exposure image 133 can be made comparable to that of the long-time exposure image 134.

In addition, the image-capturing apparatus 100 uses the image 137 for which removal of the flare from the short-time exposure image 133 and amplification have been performed, for the area around the light source, and uses the long-time exposure image 134 for the other areas aside from those around the light source. With this, it is possible to suppress image-quality deterioration due to the use of the short-time exposure image 133.

Hereinafter, the configuration and operation of the imaging device 102 shall be described in detail.

FIG. 10 is a diagram showing the configuration of the imaging device 102.

As shown in FIG. 10, the imaging device 102 includes a pixel array 300, a CDS circuit 310, a sense amplifier 320, a horizontal shift register 330, output amplifiers 331A and 331B, a power source voltage driving circuit 332, a multiplexer 333, a vertical shift register 334, an electronic shutter shift register 335, a short-time exposure shift register 336, a reference voltage generating circuit 337, a driving circuit 338, a counter 339, an output amplifier 340, and a load resistor circuit 341.

The pixel array 300 includes plural pixel cells 301A, 301B and 301C which are two-dimensionally arranged unit pixels. It should be noted that when differentiation of the pixel cells 301A, 301B and 301C is not required, they shall be referred to collectively as pixel cells 301. Furthermore, although three of the 3 row×1 column pixel cells 301 are shown in FIG. 10 in order to facilitate description, the number of the pixel cells 301 is arbitrary. Furthermore, the pixel cells 301 are assumed to be arranged in row and column directions.

Each of the pixel cells 301 converts incident light to signal voltage, and outputs the signal voltage obtained from the conversion to a signal line sl. The pixel cell 301A includes a photodiode 302, a transmission transistor 303, a reset transistor 304, and an amplifier transistor 305. Note that the pixel cells 301B and 301C are configured in the same manner. Furthermore, the configuration of the pixel cells 301 is not limited to the configuration shown in FIG. 10, and the pixel cells 301 may be configured to have a photodiode which performs photo-electric conversion, an in-pixel amplifying function, a transmission gate function, and a reset gate function.

The pixel cells 301A, 301B and 301C are arranged on the same column (the longitudinal direction in the figure).

The signal line sl and a power source voltage line vd are commonly connected to the pixel cells 301A, 301B and 301C arranged in the column direction. Control lines re1 to re3 and tran1 to tran3 are connected to the pixel cells 301A to 301C respectively. Furthermore, each of the control lines re1 to re3 and tran1 to tran3 are commonly connected to pixel cells 301 in the same row (lateral direction in the figure).

The CDS circuit 310 is a correlated double sampling circuit. The CDS circuit 310 includes plural CDS cells 311. A CDS cell 311 is arranged for each column of the pixel cells 301. It should be noted that for the sake of simplification, only one CDS cell 311 is shown in FIG. 10.

The CDS cell 311 performs correlated double sampling on the signal voltage for the short exposure time and the long exposure time, and holds respective signals for the short exposure time and the long exposure time.

Each CDS cell 311 includes transistors 312, 314, 315A, 315B, 317A and 317B, and capacitors 313, 316A and 316B.

Here, a usual CDS corresponding to one exposure time signal includes two capacitors which are connected in series. In the usual CDS, the intermediate node between the two capacitors is biased with a standard voltage during the period in which a dark signal is inputted. Subsequently, in the usual CDS cell, a bright signal is inputted and the amount of voltage change in the intermediate node is read out.

The imaging device 102 in an embodiment of the present invention includes the three capacitors 313, 316A and 316B in order to simultaneously output the short-time exposure signal 130 and the long-time exposure signal 131.

The capacitor 313 is a front-stage capacitor in serial capacitors. The capacitor 313 is used, in common, both when reading the signal for the short exposure time and when reading the signal for the long exposure time.

The capacitor 316A is a subsequent-stage capacitor in the serial capacitors, which is used when reading the signal for the long exposure time. The capacitor 316B is a subsequent-stage capacitor in the serial capacitors, which is used when reading the signal for the short exposure time.

The transistor 312 is an input transistor that enables conduction between the signal line sl and the CDS cell 311. The transistor 312 is switched ON/OFF according to a signal of a control line sh.

The transistor 314 is a switch for setting the intermediate node of the serial capacitors to a standard voltage applied by a standard voltage line av. The transistor 314 is switched ON/OFF according to a signal of a control line nccl.

The transistors 315A and 315B are switches for switching the connection between the capacitor 313 and one of the capacitors 316A and 316B. The transistors 315A and 315B are switched ON/OFF according to signal of control lines sel1 and sel2 respectively.

The transistor 317A is a switch for outputting the signal held by the capacitor 316A to a signal line hsl1. The transistor 317B is a switch for outputting the signal held by the capacitor 316B to a signal line hsl2. The transistors 317A and 317B are switched ON/OFF according to a signal of a control line hsel.

Furthermore, the control lines sh, nccl, sel1 and sel2 are commonly connected to the plural CDS cells 311.

The horizontal shift register 330 is a typical circuit which sequentially selects the columns of the pixel cells 301, based on a clock signal and a trigger signal from an external source. The horizontal shift transistor 330 selects a column by activating one of the plural control lines hsel corresponding to the column. The horizontal shift register 330 causes the signals held by the CDS cells 311 in the selected column to be outputted to the signal lines hsel1 and hsel2.

The reference voltage generating circuit 337 generates a reference voltage and outputs the generated reference voltage to a reference voltage line ref.

The output amplifiers 331A and 331B amplify the signals outputted to the signal lines hsel1 and hsel2, respectively, and outputs the amplified signals as the long-time exposure signal 131 and the short-time exposure signal 130 to output pads.

The sense amplifier 320 includes plural sense amplifier cells 321. The sense amplifier cells 321 are arranged so that each corresponds to a respective one of the CDS cells 311. Note that, for the sake of simplification, only one sense amplifier cell 321 is shown in FIG. 10.

Each of the sense amplifier cells 321 judges whether or not the image that was image-captured by the corresponding one of the pixel cells 301 is saturated. Specifically, each of the sense amplifier cells 321 judges whether or not the signal voltage for the short exposure time outputted to the signal line sh is greater than the reference voltage of the reference voltage line ref. Each of the sense amplifier cells 321 outputs the judgment result to a signal line tr. Here, the reference voltage of the reference voltage line ref is a signal voltage for the short exposure time, which corresponds to the signal voltage that saturates the pixel cells 301 in the long exposure time.

Each of the sense amplifier cells 321 includes transistors 322A, 322B and 324, and inverters 323A and 323B. It should be noted that the configuration of the sense amplifier cells 321 is not limited to the configuration shown in FIG. 10, as long as it is a circuit which judges whether or not the signal voltage for the short exposure time outputted to the signal line sh is greater than the reference value.

The power source voltage driving circuit 332 is a driving circuit which drives a power source voltage line vd.

The load resistor circuit 341 is a circuit in which the respective load resistors of the amplifier transistor 305 in the respective pixel cells 301 are formed in an array in the horizontal direction.

The vertical shift register 334 sequentially outputs driving pulses to each of the rows for the long exposure time. The electronic shutter shift register 335 is a vertical shift register for the electronic shutter. The short-time exposure shift register 336 is a vertical shift register for the short-time exposure, which sequentially outputs drive pulses to each of the rows for the short exposure time.

The multiplexer 333 selects control signals to be outputted from the vertical shift register 334, the electronic shutter shift register 335, and the short-time exposure shift register 336, and outputs the selected control signals to the control lines re1 to re3 and tran1 to tran3.

The driving circuit 338 is a circuit which includes a driver, and the like, for driving the sense amplifier 320 and the CDS circuit 310. The driving circuit 338 outputs control signals to the control lines sh, nccl, sel1 and sel2. Furthermore, the driving circuit 338 supplies the standard voltage to the standard voltage line av.

The counter 339 detects the signals outputted to the signal line tr by the sense amplifier 320, and counts the number of saturated pixels. Specifically, the counter 339 counts the number of the pixels for which the sense amplifier 320 has judged that the signal voltage outputted to the signal line sh is greater than the reference voltage of the reference voltage line ref.

The counter 339 makes the FLG signal 132 active when there is a count that is greater than a standard number of bits (hereafter referred to as standard bit number). Here, the standard bit number is the minimum value for the number of saturated pixels arising when a high-brightness subject is included in an image. In other words, since the effects of a flare is minimal when the saturated pixels included in the image is equal to or less than the standard bit number, the imaging device 100 does not perform the flare removal processing.

Furthermore, the counter 339 transmits the FLG signal 132 to the short-time exposure shift register 336. Upon receiving an active FLG signal 132, the short-time exposure shift register 336 shortens the shutter time so that there will be no saturated pixels. In other words, the imaging device 120 automatically switches the shutter time internally so that there will be no saturated pixels for the short-time exposure signal 130.

The output amplifier 340 amplifies the FLG signal 132 outputted by the counter 339, and outputs the amplified FLG signal 132 to an output pad.

Next, the operation of the imaging device 102 shall be described.

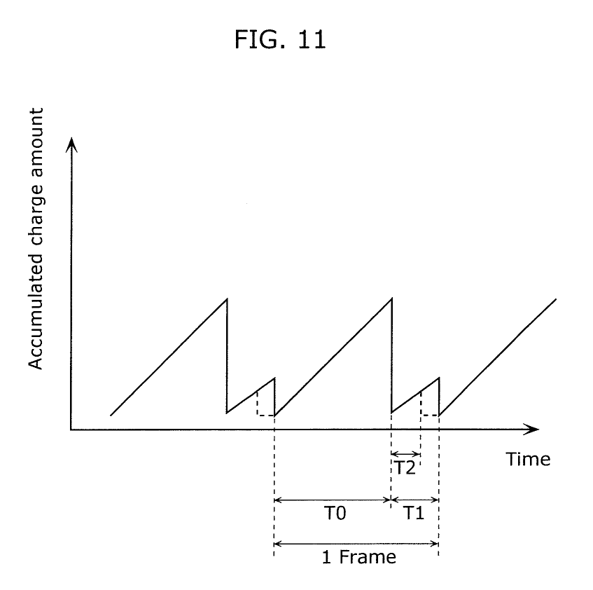

FIG. 11 is a diagram showing the control of the electronic shutter in the imaging device 102. FIG. 11 is a diagram showing the charge amount accumulated in the photodiode 302. As shown in FIG. 11, the electronic shutter shift register 335 controls the electronic shutter so that, in one frame period, signal charges are accumulated during a long exposure time T0 and a short exposure time T1, for every row.

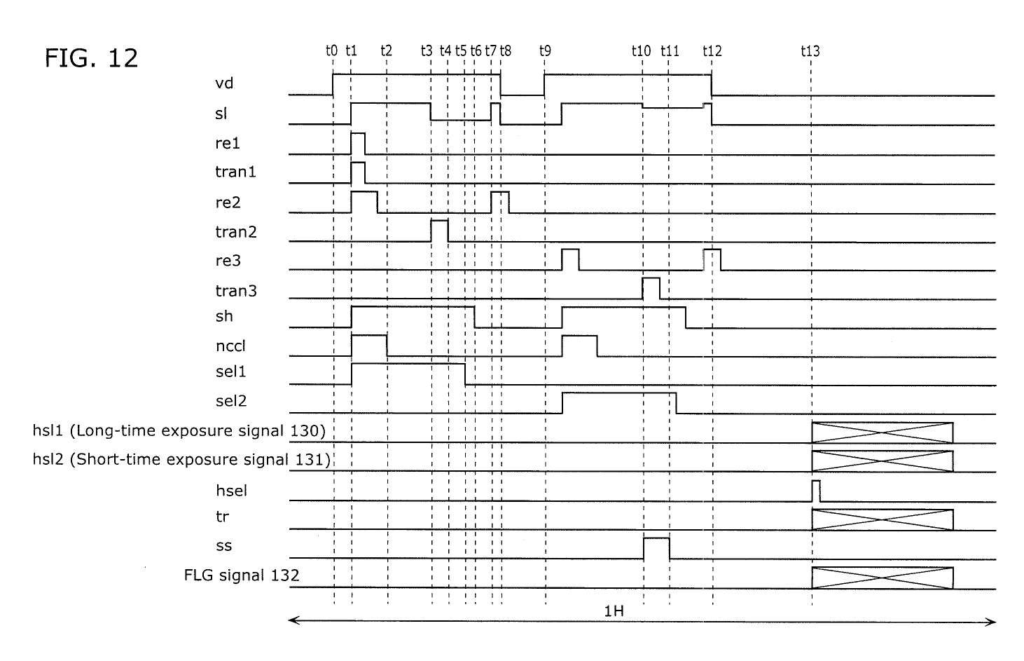

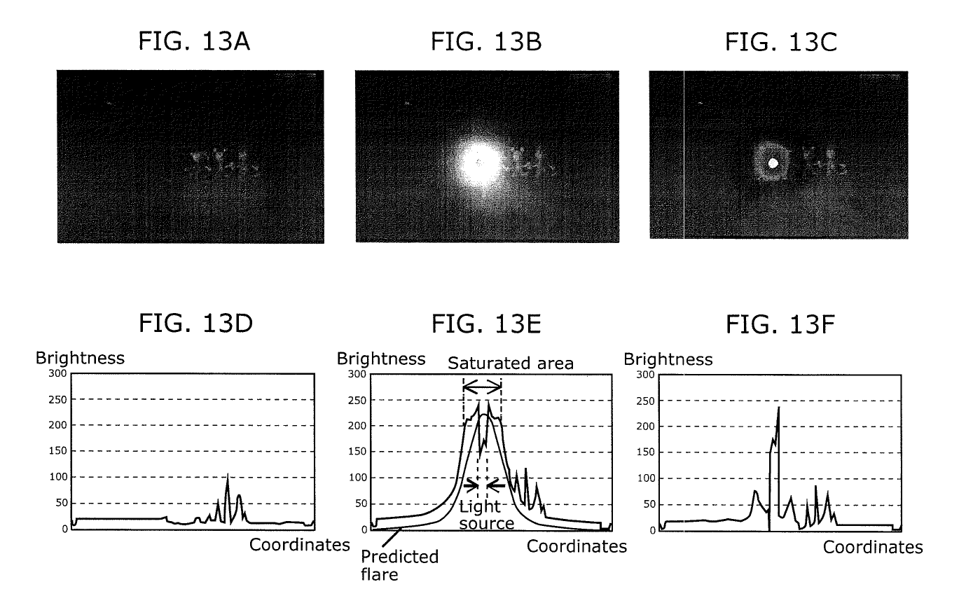

FIG. 12 is a timing chart showing the operation of the imaging device 102. The timing chart shown in FIG. 12 illustrates the operation of the imaging device 102 for one cycle of a horizontal synchronizing signal. Furthermore, the timing chart shown in FIG. 12 illustrates an example in which the signal for the long exposure time is read from the pixel cell 301B and the signal for the short exposure time is read from the pixel cell 301C.

A power source voltage is applied to the power source voltage line vd at a timing t0 which is prior to the reading of the charges accumulated in the photodiode 302.

Next, the control lines re1, tran1, re2, sh, nccl, and sel1 become active at a timing t1. The imaging device 102 simultaneously starts three operations at the timing t1, thus achieving a reduction in driving time. The three operations are as follows. The first operation is resetting the charges accumulated in the photodiode 302 of each of the set of pixel cells in the same row as the pixel cell 301A, by simultaneously activating the control line re1 and the control line tran1 with respect to the set of pixel cells. The second operation is setting the power source voltage to the gate voltage of the amplifier transistor 305 for the set of pixel cells in the same row as the pixel cell 301B.

The third operation is initializing the CDS circuit 310. Specifically, the transistor 312 turns ON with the activation of the control line sh. With this, there is conduction between the signal line sl and the CDS cell 311. Furthermore, the transistor 315A turns ON with the activation of the control line sel1. With this, the capacitor 313 and the capacitor 316A are connected. Furthermore, the transistor 314 turns ON with the activation of the control line nccl. With this, the potential of the intermediate node between the capacitor 313 and the capacitor 316A is set to the standard voltage supplied by the standard voltage line av.

Next, the control line nccl becomes inactive at the timing t2, and the standard voltage of the standard voltage line av and the intermediate node between the capacitor 313 and the capacitor 316A are cut off. In other words, the intermediate node is charged with the charges of the standard voltage.

Next, the control line tran2 becomes active at a timing t3, and the transmission transistor 303 inside the respective pixel cells 301 located in the same row as the pixel cell 301B is turned ON. Subsequently, the control line tran2 becomes inactive at a timing t4, and the transmission transistor 303 is turned OFF.

With this, the gate voltage of the amplifier transistor 305 changes in accordance with the charge amount accumulated in the photodiode. The amplifier transistor 305 changes the voltage of the signal line sl in accordance with the gate voltage. With the change in the signal line sl, the voltage of the intermediate node between the valid capacitor 313 and capacitor 316A in the CDS circuit 310 changes in accordance with the voltage of the signal line sl. As a result, voltage that is in accordance with the accumulated charges of the pixel cells 301 that are in the same row as the pixel cell 301B appears in the intermediate node between the active capacitor 313 and capacitor 316A.

Next, the control line sel1 becomes inactive at a timing t5, and the transistor 315A turns OFF. As a result, charges corresponding to the long exposure time of the pixel cell 301B are accumulated in the capacitor 316A.

The control line sh becomes inactive at a timing t6, and the transistor 312 turns OFF. With this, the signal line sl and the CDS cell 311 are cut off.

Next, the control line re2 becomes active at a timing t7, and the power source voltage line vd becomes a ground potential at a timing t8. With this, the gate voltage of the amplifier transistor 305 of the pixel cells 301 in the same row as the pixel cell 301B returns to the ground voltage.

With the above-described operation, the charges corresponding to the signal charge for the long exposure time accumulated in the pixel cell 301B are held in the capacitor 316A.

Next, imaging device 102 performs on the pixel cells 301 that are in the same row as the pixel cell 301C, the same operations as the operations performed from timing t0 to timing t8, from a timing t9 to a timing t12.

Specifically, the power source voltage is applied to the power source voltage line vd at the timing t9.

Next, the control lines re3, sh, nccl, and sel2 become active. With this, the gate voltage of the amplifier transistor 305 for the pixel cells 301 in the same row as the pixel cell 301C is set to the power source voltage. Furthermore, the CDS circuit 310 is initialized.

Next, the control line the control line tran3 becomes active, and the transmission transistor 303 inside the pixel cells 301 located in the same row as the pixel cell 301C is turned ON. Subsequently, the control line tran3 becomes inactive, and the transmission transistor 303 is turned OFF.

With this, voltage that is in accordance with the accumulated charges of the pixel cells 301 that are in the same row as the pixel cell 301C appears in the intermediate node between the active capacitor 313 and capacitor 316A.

Next, the control line sel2 becomes inactive, and the transistor 315B turns OFF. As a result, charges corresponding to the short exposure time of the pixel cell 301C are accumulated in the capacitor 316B.

Next, the control line re3 becomes active, and then the power source voltage line vd becomes the ground potential at the timing t12. With this, the gate voltage of the amplifier transistor 305 of the pixel cells 301 in the same row as the pixel cell 301C returns to the ground voltage.

With the above-described operation, the charges corresponding to the signal charge for the short exposure time accumulated in the pixel cell 301C are held in the capacitor 316B.

On the other hand, the control line ss becomes active in the period from a timing t10 to a timing t11. This drives the sense amplifier 320. Specifically, the transistors 322A and 322B are turned ON. Therefore, with the mutual feedback of output voltage by the cross-coupling combined inverters 323A and 323B, the voltage of the signal line sl and the reference voltage of the reference voltage line ref are differentially amplified. With this, the voltage of the signal line sl and the reference voltage of the reference voltage line ref are compared. When the voltage of the signal line sl is greater than the reference voltage, a node n1 becomes a ground voltage, and when the voltage of the signal line sl is less than the reference voltage, the node n1 becomes the power source voltage. In other words, when the pixel cell 301C is a saturated pixel, the node n1 becomes the ground voltage; when the pixel cell 301C is not a saturated pixel, the node n1 becomes the power source voltage.

Next, the horizontal shift register 330 is driven at a timing 13, and the control line hsel becomes active. With this, the transistors 317A, 317B and 324 turn ON.

With the turning ON of the transistor 317A, the charges held in the capacitor 316A are distributed between the capacitor 316A and a wiring parasitic capacitance of the signal line hsl1. The output amplifier 331A amplifies the capacitance-distributed voltage. The output amplifier 331A outputs the long-time exposure signal 131 which is the amplified voltage.

Furthermore, with the turning ON of the transistor 317B, the charges held in the capacitor 316B are distributed between the capacitor 316B and a wiring parasitic capacitance of the signal line hsl2. The output amplifier 331B amplifies the capacitance-distributed voltage. The output amplifier 331B outputs the short-time exposure signal 130 which is the amplified voltage.

Furthermore, with the turning ON of the transistor 324, the binary data accumulated in the sense amplifier cells 321 is sequentially transmitted to the counter 339. The counter 339 counts the number of L-level (ground voltage) binary data among the binary data sequentially transmitted from the plural sense amplifier cells 321. In other words, the counter 339 counts the number of saturated pixels.

After counting the saturated pixels for one frame, the counter 339 judges whether or not the count value is greater than the set standard bit number. The counter 339 makes the FLG signal 132 active when the count value is greater than the standard bit number. In other words, the counter 339 makes the FLG signal 132 active when a high-brightness subject such as a light source is image-captured. The output amplifier 340 amplifies the FLG signal 132 and outputs the amplified FLG signal 132 to the output pad.

Furthermore, the FLG signal 132 is inputted to the short-time exposure shift register 336. Upon receiving an active FLG signal 132, the short-time exposure shift register 336 shifts the phase of the shift register so as to shorten the short exposure time. With this, for example, the short exposure time shown in FIG. 11 becomes a time T2. Furthermore, upon receiving an inactive FLG signal 132, the short-time exposure shift register 336 shifts the phase of the shift register so as to lengthen the short exposure time. It should be noted that the FLG signal 132 is provided with a control so that the short exposure time does not become longer than a certain length.

Furthermore, the control unit 120 calculates the ratio between the short exposure time and the long exposure time, based on the FLG signal 132. In other words, based on the logic of the FLG signal 132, the control unit 120 calculates the short exposure time that has been changed by the short-time exposure shift register 336, and calculates the ratio between the calculated short exposure time and the long exposure time.

The calculated ratio is notified to the amplifying unit 113. The amplifying unit 113 amplifies the brightness of the image 136 using a gain that is in accordance with the notified ratio.

It should be noted that, the imaging device 102 may output information indicating the short exposure time, other than the FLG signal 132. In this case, the control unit 120 calculates the ratio between the short exposure time and the long exposure time, based on such information.

Therefore, the imaging device 102 can generate the short-time exposure signal 130 and the long-time exposure signal 131 by image-capturing the subject 20 using different exposure times.

Furthermore, the imaging device 102 outputs an FLG signal 132 which becomes active when a high-brightness subject such as a light source is detected. With this, the imaging device 100 can judge whether or not a high-brightness subject is included in an image outputted from the imaging device 102.

In addition, the image-capturing apparatus 102 can implement the function for automatically controlling the ratio between the short exposure time and the long exposure time using the FLG signal 132. With this, the imaging device 102 can automatically perform control so that the image signals for the short exposure time are not saturated.

Although the image-capturing apparatus in an embodiment of the present invention has been described thus far, the present invention is not limited to such embodiment.

For example, although one imaging device 102 generates the short-time exposure signal 130 and the long-time exposure signal 131 in the preceding description, the short-time exposure signal 130 and the long-time exposure signal 131 may be respectively generated by two imaging devices.

Furthermore, although the image-capturing apparatus according to the present invention is exemplified as an in-vehicle camera equipped in the vehicle 10 in the preceding description, the image-capturing apparatus according to the present invention may be applied to a surveillance camera and a digital video camera. Even in such cases, the image-capturing apparatus according to the present invention can, in the same manner as in the preceding description, reduce the effects of a flare when a high-brightness subject is image-captured.

Furthermore, the present invention may be applied to an image-capturing apparatus such as a digital still camera which image-captures still pictures.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to an image-capturing apparatus, and particularly to an in-vehicle camera equipped in a vehicle and so on.

What is claimed is:

1. An image-capturing apparatus comprising:
a solid-state imaging device which generates a first image by image-capturing a subject using a first exposure time;
a predicted-flare generating unit configured to generate a predicted-flare image showing a flare component included in the first image;
a subtracting unit configured to generate a difference image by subtracting the predicted-flare image from the first image; and
an amplifying unit configured to generate an amplified image by amplifying the difference image.

2. The image-capturing apparatus according to claim 1,
wherein said solid-state imaging device is further configured to generate a second image by image-capturing the subject using a second exposure time which is longer than the first exposure time,
said image-capturing apparatus further comprises:
an extracting unit configured to generate a flare area image by extracting an image in a first area in the amplified image;
an excluding unit configured to generate an excluded image by excluding, from the second image, an image in an area in the second image corresponding to the first area; and
a synthesizing unit configured to synthesize the flare area image and the excluded image, and
the first area is an area in the first image, in which the flare component is included.

3. The image-capturing apparatus according to claim 2,
wherein said amplifying unit is configured to amplify the difference image according to a ratio between the first exposure time and the second exposure time.

4. The image-capturing apparatus according to claim 2,
wherein said extracting unit is configured to generate the flare area image by multiplying the amplified image by a flare area function which normalizes a brightness of the flare component to a value ranging from 0 to 1, the flare area function being inversely proportional to a distance from a center of the flare component.

5. The image-capturing apparatus according to claim 4,
wherein said excluding unit is configured to generate the excluded image by multiplying the second image by a flare area excluding function obtained by subtracting the flare area function from 1.

6. The image-capturing apparatus according to claim 1,
wherein said predicted-flare generating unit includes:
a barycenter calculating unit configured to calculate, for each of plural areas into which the first image is divided, a barycenter of first pixels having a brightness greater than a first value;
a divisional predicted-flare calculating unit configured to calculate, for each of the plural areas, a divisional predicted-flare image showing a flare component having the barycenter as a center; and
a predicted-flare synthesizing unit configured to generate the predicted-flare image by synthesizing the respective divisional predicted-flare images calculated for each of the plural areas.

7. The image-capturing apparatus according to claim 6,
wherein said divisional predicted-flare calculating unit is configured to calculate the divisional predicted-flare image for each of the plural areas, by multiplying a predicted-flare function by the number of the first pixels included in the area, the predicted-flare function being inversely proportional to a distance from the barycenter and indicating a brightness of the flare component.

8. The image-capturing apparatus according to claim 2,
wherein said solid-state imaging device includes:
plural pixels arranged two-dimensionally, each of which converts incident light into a signal voltage;
a voltage judging unit configured to judge, for each of the plural pixels, whether or not the signal voltage is greater than a reference voltage,
said image-capturing apparatus further comprises to counter unit configured to count the number of the pixels judged by said voltage judging unit as having a signal voltage greater than the reference voltage, and
when the number of the pixels counted by said counter unit is greater than a second value, said predicted-flare generating unit is configured to generate the predicted-flare image, said subtracting unit is configured to generate the difference image, and said amplifying unit is configured to generate the amplified image.

9. The image-capturing apparatus according to claim 8,
wherein said solid-state imaging device includes an exposure time adjustment unit configured to shorten the first exposure time when the number of the pixels counted by said counter unit is greater than the second value.

10. The image-capturing apparatus according to claim 9,
wherein said solid-state imaging device further includes a signal generating unit configured to generate a first signal when the number of the pixels counted by said counter unit is greater than the second value,
said image-capturing apparatus further comprises a first exposure time calculating unit configured to calculate, based on the first signal, the first exposure time shortened by said exposure time adjusting unit, and
said amplifying unit is configured to amplify the difference image according to a ratio between the first exposure time calculated by said first exposure time calculating unit and the second exposure time.

11. The image-capturing apparatus according to claim 2,
wherein said solid-state imaging device includes:
plural pixels arranged two-dimensionally, each of which converts incident light into signal voltage;
a correlated double sampling circuit which performs correlated double sampling on the signal voltage for the first exposure time and the signal voltage for the second exposure time, and holds a signal for the first exposure time and a signal for the second exposure time;
a first output unit configured to generate the first image by amplifying the signal for the first exposure time held in said correlated double sampling circuit, and to output the generated first image; and
a second output unit configured to generate the second image by amplifying the signal for the second exposure time held in said correlated double sampling circuit, and to output the generated second image.

12. A camera comprising the image-capturing device according to claim 1.

13. A vehicle comprising the camera according to claim 12.

14. An image-capturing method used in an image-capturing apparatus including a solid-state imaging device which image-captures an image of a subject using a first exposure time and generates a first image, said image-capturing method comprising:
generating a predicted-flare image showing a flare component included in the first image;
generating a difference image by subtracting the predicted-flare image from the first image; and
generating an amplified image by amplifying the difference image.
